(19) United States
(12) Patent Application Publication
(10) Pub. No.: US 2013/0106065 A1
(43) Pub. Date: May 2, 2013

(54) Multi-Layer Inserts for Gaskets

(71) Applicant: David J. Schweiger, Pewaukee, WI (US)

(72) Inventor: David J. Schweiger, Pewaukee, WI (US)

(73) Assignee: DANA AUTOMOTIVE SYSTEMS GROUP, LLC, Maumee, OH (US)

(21) Appl. No.: 13/287,588

(22) Filed: Nov. 2, 2011

(51) Int. Cl. F02F 11/00; B21D 53/84

(52) U.S. Cl. 277/594; 277/598; 29/888.3

(57) ABSTRACT

A multi-layer insert for a gasket having a retention tab having a first position and a second position is provided. The multi-layer insert includes a first plate, a second plate having the retention tab formed therein, and a third plate. The first plate and the second plate are coupled to the third plate. The retention tab in the first position partially defines a first profile of the second plate and the retention tab in the second position extends outwardly from the first profile of the second plate. An indent formed in the third plate receives a portion of the second plate when the retention tab is placed in the second position.

### FIELD OF THE INVENTION

The invention relates to a multi-layer steel insert for a gasket, such as a cylinder head gasket for use in an internal combustion engine.

### BACKGROUND OF THE INVENTION

A cylinder head gasket for an internal combustion engine seals a joint formed between a cylinder head and a cylinder block. The cylinder block has a plurality of openings formed therein, which include cylinder bores, fluid passages, fastener apertures, and the like. Fluctuations in temperature and pressure within the joint can result in alternating stresses and motions. Depending on the location of each of the openings in the cylinder block, the alternating stresses and motions can create a significant sealing challenge.

Traditionally, a gasket including a molded rubber insert is used to seal fluid passages that are exposed to a light loading or exposed to high lift-off forces. However, in many applications the molded rubber insert cannot adequately conform to the cylinder head and the cylinder block as a result from temperature fluctuations or mechanical motion. Additionally, prolonged exposure to fluids such as coolant, water, and oil, as well as additives or contaminants within such fluids leads to a degradation of the material properties of the molded rubber insert or causes compression set of the molded rubber insert. As a result, a sealing stress applied by the molded rubber insert is significantly reduced.

In view of the foregoing disadvantages of the prior art, it would be advantageous for a gasket to have an insert that can accommodate stresses applied by the cylinder head and the cylinder block as a result of temperature fluctuations and mechanical motion while maintaining a desired seal therebetween. Further, it would be advantageous for the insert for the gasket to minimize compression set or relaxation often seen in prior art designs, to provide improved wear resistance, to provide improved fluid and temperature resistance, to provide improved recovery characteristics, and to provide an improved seal.

### SUMMARY OF THE INVENTION

Provided by the invention, a gasket insert able to resist thermal motion damage, militate against compression set, and militate against relaxation, has surprisingly been discovered.

In one embodiment, the invention is directed towards a multi-layer insert for a gasket including a first plate and a second plate. The first plate has an inner peripheral edge defining an aperture therethrough and at least one first plate retention tab extending from an outer peripheral edge thereof. The second plate has an inner peripheral edge defining an aperture therethrough and an outer peripheral edge defining at least one second plate retention tab. Each second plate retention tab has a first position and a second position. Each second plate retention tab in the first position and the second position is substantially coplanar with the second plate. The outer peripheral edge of the second plate and each second plate retention tab in the first position defines a first profile of the second plate. The first plate and the second plate are fixed with respect to one another and a portion of the at least one second plate retention tab in the second position extends outwardly from the first profile of the second plate.

In another embodiment, the invention is directed towards a method for securing a multi-layer insert to a cylinder head gasket. The method comprises the steps of providing a first plate having at least two first plate retention tabs extending from an outer peripheral edge thereof, providing a second plate having an outer peripheral edge defining at least two second plate retention tabs, at least one embossment formed adjacent each of the second plate retention tabs, the at least two second plate retention tabs being substantially coplanar with the second plate and the outer peripheral edge of the second plate and the at least one second plate retention tab defining a first profile of the second plate, providing a third plate having an outer peripheral edge defining at least two third plate indents, coupling the first plate and the second plate to the third plate to form the multi-layer insert having an insert profile, each of the third plate indents substantially aligned with at least two second plate retention tabs formed in the second plate, providing the cylinder head gasket having a gasket edge at least partially corresponding to the insert profile, abuttingly disposing the multi-layer insert against the gasket edge, the at least two first plate retention tabs disposed against a first face of the cylinder head gasket and extending past the gasket edge, and deforming a portion of the second plate including at least one of the embossments formed in the second plate, wherein the portion of the second plate deformed is received by the third plate indents, such deformation causing at least a portion of each of the second plate retention tabs to extend outwardly from the first profile of the second plate, each of the second plate retention tabs disposed against a second face of the cylinder head gasket and extending past the gasket edge to couple the multi-plate insert to the cylinder head gasket.

### BRIEF DESCRIPTION OF THE DRAWINGS

The above, as well as other advantages of the invention will become readily apparent to those skilled in the art from the following detailed description when considered in the light of the accompanying drawings in which:

FIG. 1 is a top view of a gasket including three multi-layer inserts according to an embodiment of the invention;

FIG. 2 is an exploded perspective view of one of the multi-layer inserts shown in FIG. 1;

FIG. 3 is a perspective view of one of the multi-layer inserts shown in FIG. 1;

FIG. 4 is a detail view of a retention tab of the multi-layer inserts shown in FIG. 3, the retention tab in a first position;

FIG. 5 is a detail view of a retention tab of the multi-layer inserts shown in FIG. 3, the retention tab in a second position;

FIG. 6 is a cross-sectional view of the multi-layer insert shown in FIG. 3, the cross-sectional view taken along line 6-6; and

FIG. 7 is a cross-sectional view of the multi-layer insert according to an alternate embodiment of the invention, the cross-sectional view similar to the view shown in FIG. 6.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

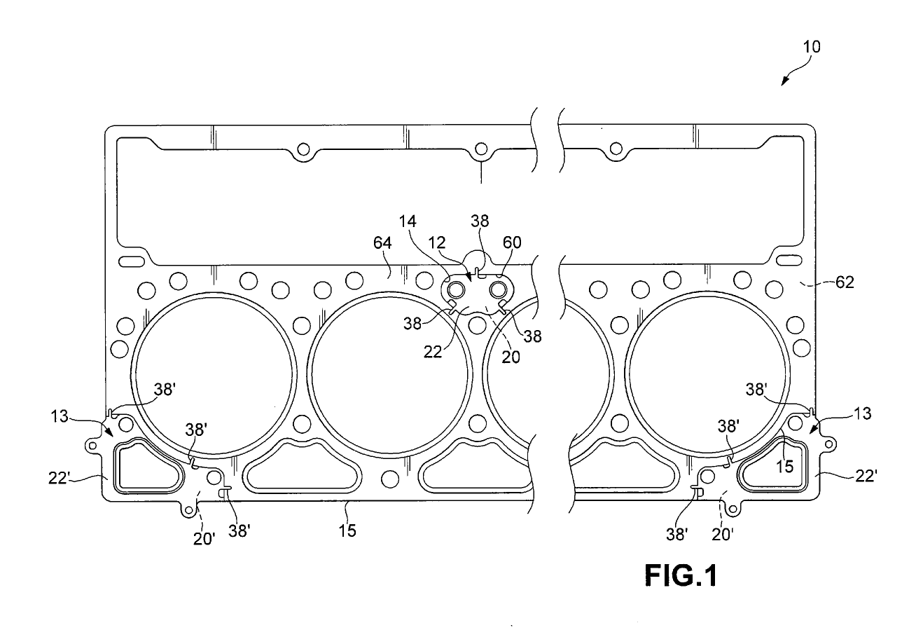

FIG. 1 illustrates a gasket 10 according to an embodiment of the invention. The gasket 10 is typically situated between a cylinder head and a cylinder block, however, it is understood the gasket 10 may be utilized in other applications. The gasket 10 may be made from metal, a composite material, or a combination of the two. The gasket 10 as shown is manufactured in accordance with the shapes of an engine block and an engine head, and includes numerous openings, such as fluid openings for coolant and oil, bolt holes and openings for cylinder bores. As is known in the art, the gasket 10 may be a multi-layer gasket having steel backed graphite layers bonded to opposing sides of a steel reinforcing core.

As shown in FIG. 1, the gasket 10 includes a multi-layer insert 12 and two edge multi-layer inserts 13. Each of the inserts 12, 13 are abuttingly disposed against and coupled to the gasket 10. As shown, the multi-layer insert 12 is disposed against an inner edge 14 of the gasket 10 and two edge multi-layer inserts 13 are disposed against an outer edge 15 of the gasket 10 to form a gasket corner. Each of the inserts 12, 13 is shaped to correspond to a portion of one of the inner edge 14 and the outer edge 15 of the gasket 10. It is understood that any number and any combination of inserts 12, 13 may be disposed against and coupled to the gasket 10. The multi-layer insert 12 preferably defines at least one fluid passage therethrough. The at least one fluid passage may include at least one of a coolant passage and a lubricant passage. Alternately, where the multi-layer insert 12 is used as a load limiter or for other such purposes, it is understood the multi-layer insert 12 may not define at least one fluid passage therethrough. Further, as shown in FIG. 1, the edge multi-layer insert 13 is disposed against the outer edge 15 of the gasket 10 to form a gasket corner, it is contemplated that the edge multi-layer insert 13 include fastener apertures formed therein. When the gasket 10 is a multi-layer gasket, it is understood a portion of the steel backed graphite layers may be removed to facilitate coupling of the multi-layer insert 12 and the edge multi-layer insert 13 to the gasket 10.

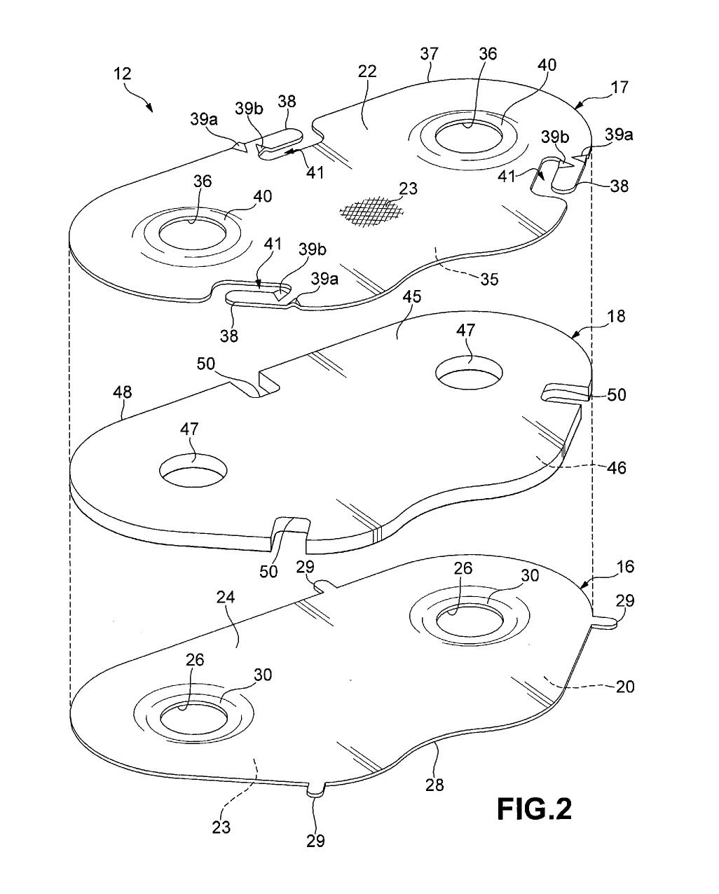

FIGS. 2, 3, 4, and 5 illustrate the multi-layer insert 12 according to an embodiment of the invention. The multi-layer insert 12 includes a first plate 16, a second plate 17, and a third plate 18. It is understood that the multi-layer insert may include any other number of plates. Each of the plates 16, 17, 18 is unitarily formed from a steel in a stamping operation or a plurality of stamping operations. However, the plates 16, 17, 18 may be formed from other metals using any other process. Further, each of the plates 16, 17, 18 may be formed from a plurality of pieces coupled together. Preferably, the first plate 16 and the third plate 18 are formed from a stainless steel and include a coating 23 disposed on a first plate outer surface 20 and a second plate outer surface 22.

The first plate 16 includes the first plate outer surface 20, a first plate inner surface 24, a first plate inner peripheral edge 26, a first plate outer peripheral edge 28, at least one first plate retention tab 29, and at least one first plate half bead 30.

The first plate outer surface 20 has a coating 23 disposed thereon and the first plate outer surface 20 may be prepared to facilitate an application of the coating 23 thereto. As a non-limiting example, an elastomeric coating, such as silicone, NBR, SBR, EPDM, FKM, or others may be applied to the first plate outer surface 20. Alternately, other materials may also be used or no coating may be applied to the first plate outer surface 20.

The first plate inner surface 24 may have an adhesive disposed thereon and the first plate inner surface 24 may be prepared to facilitate an application of the adhesive thereto. As a non-limiting example, a rubber adhesive may be applied to the first plate inner surface 24. It is understood, however, that other adhesives may also be used. Further, it is also understood that the plates 16, 17, 18 may be coupled to one another using at least one eyelet, at least one rivet, a form-locked engagement, a shear-locked engagement, at least one spot weld, or any other appropriate mechanical coupling.

The first plate inner peripheral edge 26 defines an aperture through the first plate 16. As shown, the first plate 16 includes two first plate inner peripheral edges 26 defining two circular apertures therethrough. However, it is understood that the first plate 16 may include fewer or more first plate inner peripheral edges 26 defining apertures of any shape.

The first plate outer peripheral edge 28 defines a first plate profile. As shown, the first plate outer peripheral edge 28 defines three first plate retention tabs 29; however, it is understood that the first plate 16 may include any number of first plate retention tabs 29.

The first plate retention tabs 29 are elongate protuberances unitarily formed and coplanar with the first plate 16 and extending from the first plate outer peripheral edge 28. Each of the first plate retention tabs 29 has a thickness equal to a thickness of the first plate 16. As shown, each of the first plate retention tabs 29 has a rounded distal end; however it is understood that each of the first plate retention tabs 29 may include distal ends having any other shape. Further, it is understood that the first plate retention tabs 29 may be formed separate from the first plate 16 and attached thereto in any conventional manner, that the first plate retention tabs 29 may be non-coplanar with the first plate 16, and that the first plate retention tabs 29 may be any thickness. As shown, the first plate retention tabs 29 are spaced equidistantly about the first plate outer peripheral edge 28; however the first plate retention tabs 29 may be arranged depending on a shape of the multi-layer insert 12 or the fastening requirements of the multi-layer insert 12.

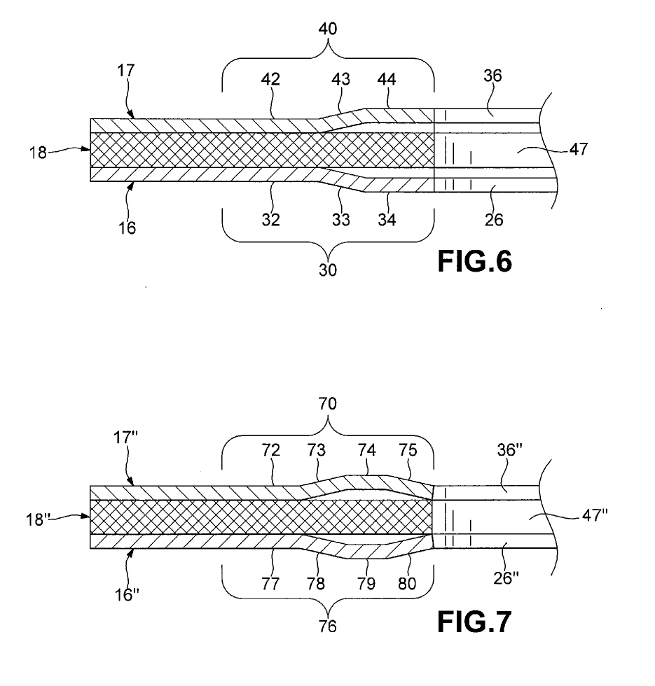

The first plate half beads 30 are formed adjacent the first plate inner peripheral edges 26. One of the first plate half beads 30 is shown in FIG. 6. The first plate half bead 30 is unitarily formed with the first plate 16 and includes a first planar portion 32, a first ramp portion 33, and a second planar portion 34. It is understood the first plate half beads 30 may be formed in either direction with respect to the third plate 18, where a direction of the first plate half beads 30 may be dependent on a number of layers of the multi-layer insert 12.

The first planar portion 32 is a portion of the first plate 16 located outwardly from each of the first plate inner peripheral edges 26. The first ramp portion 33 is a portion of the first plate 16 oblique to the first planar portion 32 located outwardly from each of the first plate inner peripheral edges 26 and inwardly from each of the first planar portions 32. As shown in FIG. 6, the first ramp portion 33 extends away from the third plate 18. The first ramp portion 33 may be formed in the first plate 16 during the stamping operation used to form the first plate 16 or may be formed in a secondary operation after the stamping operation used to form the first plate 16.

The second planar portion 34 is a portion of the first plate 16 parallel to the first planar portion 32 located inwardly from each of the first ramp portions 33. As shown in FIG. 6, the second planar portion 34 is noncoplanar with the first planar portion 32. The second planar portion 34 may be formed in the first plate 16 during the stamping operation used to form the first plate 16 or may be formed in a secondary operation after the stamping operation used to form the first plate 16.

The second plate 17 includes the second plate outer surface 22, a second plate inner surface 35, a second plate inner peripheral edge 36, a second plate outer peripheral edge 37, at least one second plate retention tab 38, at least one embossment 39a, 39b, and at least one second plate half bead 40.

The second plate outer surface 22 may have the coating 23 disposed thereon and the second plate outer surface 22 may be prepared to facilitate an application of the coating 23 thereto. As a non-limiting example, an elastomeric coating, such as silicone, NBR, SBR, EPDM, FKM, or others may be applied to the second plate outer surface 22. Alternately, other materials may also be used or no coating may be applied to the second plate outer surface 22.

The second plate inner surface 35 may have an adhesive disposed thereon and the second plate inner surface 35 may be prepared to facilitate an application of the adhesive thereto. As a non-limiting example, a rubber adhesive may be applied to the second plate inner surface 35. It is understood, however, that other adhesives may also be used. Further, it is also understood that the plates 16, 17, 18 may be coupled to one another using at least one eyelet, at least one rivet, a form-locked engagement, a shear-locked engagement, at least one spot weld, or any other appropriate mechanical coupling.

The second plate inner peripheral edge 36 defines an aperture through the second plate 17. As shown, the second plate 17 includes two second plate inner peripheral edges 36 defining two circular apertures therethrough. However, it is understood that the second plate 17 may include fewer or more second plate inner peripheral edges 36 defining apertures of any shape.

The second plate outer peripheral edge 37 defines three second plate retention tabs 38; however, it is understood that the second plate 17 may include any number of second plate retention tabs 38. The second plate outer peripheral edge 37 similarly defines three retention tab gaps 41. A shape of each of the retention tab gaps 41 is substantially “L” shaped; however, it is understood that the retention tab gaps 41 may be any other shape. Each of the retention tab gaps 41 is an interstitial space between each of the second plate retention tabs 38 and a remaining portion of the second plate 17. Alternately, the second plate outer peripheral edge 37 may define the second plate retention tabs 38 without defining the retention tab gaps 41.

The second plate retention tabs 38 are elongate protuberances unitarily formed and coplanar with the second plate 17 and extending from the second plate outer peripheral edge 37. Each of the second plate retention tabs 38 has a thickness equal to a thickness of the second plate 17.

The second plate retention tabs 38 have a first position and a second position. As shown in FIGS. 1 and 5, the second plate retention tabs 38 are in a second position. As shown in FIGS. 2, 3, and 4, the second plate retention tabs 38 are in a first position. When the second plate retention tabs 38 are in the first position, the second outer peripheral edge 37 and the second plate retention tabs 38 define a first profile of the second plate 17. When the second plate retention tabs 38 are in the second position, the second plate outer peripheral edge 37 and the second plate retention tabs 38 define a second profile of the second plate 17. When the second plate retention tabs 38 are in the second position, the second plate retention tabs 38 extend outwardly from the first profile of the second plate 17.

The second plate retention tabs 38 in the first position and the second position are substantially coplanar with the second plate 17. As shown, each of the second plate retention tabs 38 has a rounded distal end; however it is understood that each of the second plate retention tabs 38 may include distal ends having any other shape. Further, it is understood that the second plate retention tabs 38 may be formed separate the second plate 17 and attached thereto in any conventional manner, that the second plate retention tabs 38 may be non-coplanar with the second plate 17, and that the second plate retention tabs 38 may be any thickness. As shown, the second plate retention tabs 38 are spaced equidistantly about the second plate outer peripheral edge 37; however, the second plate retention tabs 38 may be arranged depending on a shape of the multi-layer insert 12 or the fastening requirements of the multi-layer insert 12.

As most clearly shown in FIG. 4, when each of the second plate retention tabs 38 of the second plate 17 are in the first position, the second plate 17 includes two embossments 39a, 39b formed adjacent each second plate retention tab 38. Alternately, the second plate 17 may include any number of embossments 39a, 39b formed adjacent each second plate retention tab 38 when each of the second plate retention tabs 38 of the second plate 17 are in the first position. Each embossment 39a, 39b is a stamped portion of the second plate 17 extending outwardly from the second plate outer surface. The second plate 17 includes an outer embossment 39a and an inner embossment 39b.

To form the embossments 39a, 39b, the second plate 17 is placed between two dies and a pressure is applied to the second plate to 17 to draw a portion of the second plate 17 away from a remaining portion of the second plate 17 to form the embossment 39a, 39b.

Each of the embossments 39a, 39b is substantially triangular in shape and form a portion of the second plate outer peripheral edge 37. A depth of each embossment 39a, 39b decreases as a distance from the second plate outer peripheral edge 37 increases. Alternately, the embossments 39a, 39b may have any other shape.

Each embossment 39a is formed adjacent each second plate retention tab 38 and forms a portion of the second plate outer peripheral edge 37. The embossments 39a face outwardly from the second plate 17.

Each embossment 39b is formed adjacent each second plate retention tab 38 and each retention tab gap 41. Each embossment 39b also forms a portion of the second plate outer peripheral edge 37. The embossments 39b face inwardly towards the second plate 17.

The second plate half beads 40 are formed adjacent the second plate inner peripheral edges 36. One of the second plate half beads 40 is shown in FIG. 6. The second plate half bead 40 is unitarily formed with the second plate 17 and includes a first planar portion 42, a first ramp portion 43, and a second planar portion 44. The first planar portion 42 is a portion of the second plate 17 located outwardly from each of the second plate inner peripheral edges 36. The first ramp portion 43 is a portion of the second plate 17 oblique to the first planar portion 42 located outwardly from each of the second plate inner peripheral edges 36 and inwardly from each of the first planar portions 42. As shown in FIG. 6, the first ramp portion 43 extends away from the third plate 18. The first ramp portion 43 may be formed in the second plate 17 during the stamping operation used to form the second plate 17 or may be formed in a secondary operation after the stamping operation used to form the second plate 17. The second planar portion 44 is a portion of the second plate 17 parallel to the first planar portion 42 located inwardly from each of the first ramp portions 43. As shown in FIG. 6, the second planar portion 44 is noncoplanar with the first planar portion 42. The second planar portion 44 may be formed in the second plate 17 during the stamping operation used to form the second plate 17 or may be formed in a secondary operation after the stamping operation used to form the second plate 17. It is understood the second plate half beads 40 may be formed in either direction with respect to the third plate 18, where a direction of the second plate half beads 40 may be dependent on a number of layers of the multi-layer insert 12.

The third plate 18 includes a first outer surface 45, a second outer surface 46, a third plate inner peripheral edge 47, a third plate outer peripheral edge 48, and at least one third plate indent 50. As shown, a thickness of the third plate 18 is about twice as thick as a thickness of each of the first plate 16 and the second plate 17; however, it is understood that the third plate 18 may be of any thickness. The thickness of the third plate 18 rigidizes the multi-layer insert 12; however, the thickness of the multi-layer insert 12 may be varied to create other desirable characteristics. Preferably, the third plate 18 is formed from a steel in a stamping process. Alternately, the third plate 18 may be formed from other metals using any other process.

The first outer surface 45 may have an adhesive disposed thereon and the first outer surface 45 may be prepared to facilitate an application of the adhesive thereto. The second outer surface 46 may have an adhesive disposed thereon and the second outer surface 46 may be prepared to facilitate an application of the adhesive thereto. As a non-limiting example, a rubber adhesive may be applied to the first outer surface 45 and the second outer surface 46. It is understood, however, that other adhesives may also be used. Further, it is also understood that the plates 16, 17, 18 may be coupled to one another using at least one eyelet, at least one rivet, a form-locked engagement, a shear-locked engagement, at least one spot weld, or any other appropriate mechanical coupling.

The third plate inner peripheral edge 47 defines an aperture through the third plate 18. As shown, the third plate 18 includes two third plate inner peripheral edges 47 defining two circular apertures therethrough, each of the third plate inner peripheral edges 47 substantially corresponds to the first plate inner peripheral edges 26 and the second plate inner peripheral edges 36. However, it is understood that the third plate 18 may include fewer or more third plate inner peripheral edges 47 defining apertures of any shape.

The third plate outer peripheral edge 48 corresponds to a third plate profile. As most clearly shown in FIG. 2, the third plate outer peripheral edge 48 defines three third plate indents 50; however, it is understood that the third plate 18 may include any number of third plate indents 50. Each of the third plate indents 50 is substantially rectangular in shape and includes rounded corners; however, it is understood that the third plate indents 50 may be any shape. As shown, the third plate indents 50 are spaced equidistantly about the third plate outer peripheral edge 48 and substantially correspond to the embossments 39a.

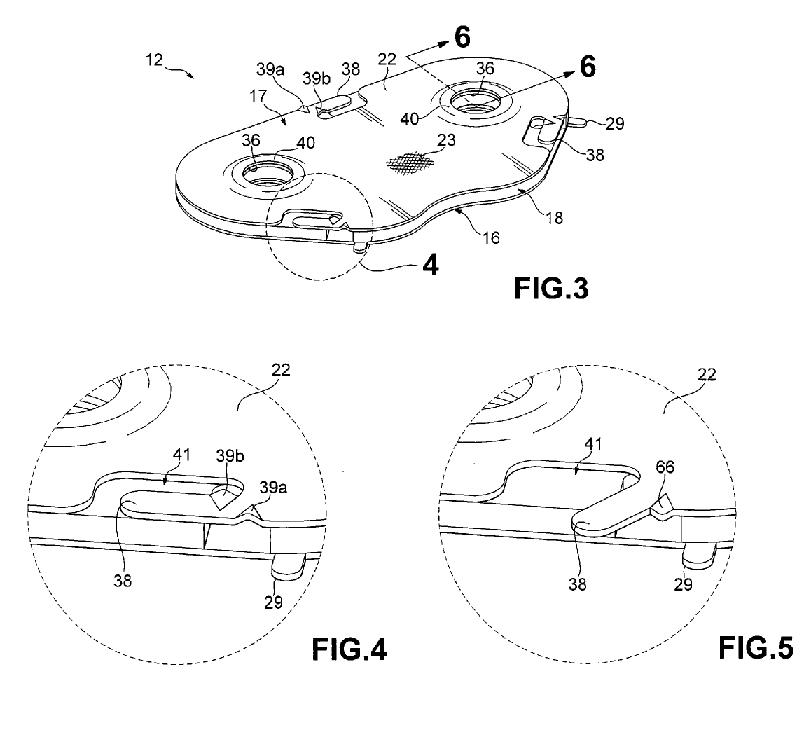

The first plate 16, the second plate 17, and the third plate 18 are coupled together to form the multi-layer insert 12. In anticipation of coupling, the first plate profile and the second plate profile are aligned with the third plate profile. As such, the first plate inner peripheral edges 26 and the second plate inner peripheral edges 36 are respectively aligned with each of the third plate inner peripheral edges 47 to form a portion of a fluid conduit. The first plate retention tabs 29 are formed to be respectively adjacent each of third plate indents 50 when the first plate 16 is aligned with the third plate 18, as most clearly shown in FIGS. 3, 4, and 5. Alternately, the first plate retention tabs 29 may be formed at any other location on the first plate outer peripheral edges 28. The second plate retention tabs 38 are formed to substantially correspond to each of third plate indents 50 when the second plate 17 is aligned with the third plate 18, as most clearly shown in FIGS. 3, 4, and 5.

After application of the adhesive to at least one of the first plate inner surface 24, the second plate inner surface 35, the first outer surface 45, and the second outer surface 46, the first plate 16 and the second plate 17 are abuttingly disposed against the third plate 18. A force may be applied to the first plate outer surface 20 and the second plate outer surface 22 until the adhesive is cured. Alternately, the first plate 16, the second plate 17, and the third plate 18 may be coupled with a weld, a plurality of welds, or any other fastener conventionally used to couple multi-layer inserts and multi-layer gaskets.

Following assembly of the multi-layer insert 12, the multi-layer insert 12 is coupled to the gasket 10. When the multi-layer insert 12 is disposed in a gasket aperture 60 defined by the inner edge 14 of the gasket 10, the inner edge 14 of the gasket 10 substantially corresponds to a profile of the multi-layer insert 12. When the edge multi-layer insert 13 is disposed against the outer edge 15 of the gasket 10, a portion of the outer edge 15 of the gasket 10 substantially corresponds to a portion of the edge multi-layer insert 13.

Where the multi-layer insert 12 is inserted into the gasket aperture 60, the second plate 17 and the third plate 18 enter the gasket aperture 60 and the first plate retention tabs 29 abut the gasket 10. Typically, a portion of a first face 62 of the gasket 10 corresponding to the first plate retention tabs 29 is removed in preparation of coupling the multi-layer insert 12 to the gasket 10, allowing the first plate outer surface 20 to be substantially coplanar with the first face 62 and the second plate outer surface 22 to be substantially coplanar with a second face 64 of the gasket 10. Alternately, where the gasket 10 includes the first face 62 able to be deformed, an additional force may be applied to the multi-layer insert 12, causing the first plate retention tabs 29 to enter the first face 62 of the gasket 10. Further, it is understood that at least a portion of the first plate outer surface 20 may be temporarily positioned between the first face 62 and the second face 64 by the additional force in anticipation of moving each of the second plate retention tabs 38 from the first position to the second position.

To secure the multi-layer insert 12 to the gasket 10, a tool (not shown) is pressed against the embossment 39a. FIG. 4 illustrates the multi-layer insert 12 prior to deformation of the embossment 39a. When the tool is pressed against the embossment 39a forming a portion of the second plate profile, a portion of the second plate retention tab 38 abuts the first outer surface 45 of the third plate 18 and the embossment 39a is deformed and received by the third plate indent 50 corresponding to each embossment 39a, forming a depression 66. FIG. 5 illustrates the multi-layer insert 12 including the depression 66. Such deformation increases a tension in the second plate 17 adjacent the embossment 39a. The tension is most strongly exerted between the embossments 39a, 39b formed adjacent each second plate retention tab 38, causing the embossment 39b to flatten and the second plate retention tab 38 to rotate outwardly away from the second plate 17. To ensure the second plate retention tab 38 rotates in a substantially coplanar manner to the second plate 17, a force may be applied to the second plate retention tab 38 with a second tool or a non-moving portion of the tool used to form the depression 66.

FIG. 1 illustrates the edge multi-layer insert 13 for a gasket 10. Similar structural features of the multi-layer insert 12 include the same reference numeral and a prime (′) symbol.

Where the edge multi-layer insert 13 is disposed against the outer edge 15 of the gasket 10, the first plate retention tabs (not shown) abut the first face 62 of the gasket 10. Typically, the portion of the first face 62 of the gasket 10 corresponding to the first plate retention tabs is removed in preparation of coupling the edge multi-layer insert 13 to the gasket 10, allowing the first plate outer surface 20′ to be substantially coplanar with the first face 62 and the second plate outer surface 22′ to be substantially coplanar with the second face 64 of the gasket 10. Alternately, where the gasket 10 includes the first face 62 able to be deformed, an additional force may be applied to the edge multi-layer insert 13, causing the first plate retention tabs to enter the first face 62 of the gasket 10. Further, it is understood that at least a portion of the first plate outer surface 20′ may be temporarily positioned between the first face 62 and the second face 64 by the additional force in anticipation of moving each of the second plate retention tabs 38′ from the first position to the second position. To secure the edge multi-layer insert 13 to the gasket 10 the edge multi-layer insert 13 is disposed adjacent against, a tool (not shown) is pressed against the embossment (not shown) to deform the embossment and the second plate retention tabs 38′ in a similar manner to the method described above.

FIG. 7 shows an alternative embodiment of the multi-layer insert 12 for the gasket 10. Similar structural features of the manifold assembly include the same reference numeral and a double prime (″) symbol.

FIG. 7 illustrates second plate whole beads 70 formed adjacent the second plate inner peripheral edges 36″. One of the second plate whole beads 70 is shown in FIG. 7. The second plate whole bead 70 is unitarily formed with the second plate 17″ and includes a first planar portion 72, a first ramp portion 73, a second planar portion 74, and a second ramp portion 75.

The first planar portion 72 is a portion of the second plate 17″ located outwardly from each of the second plate inner peripheral edges 36″. The first ramp portion 73 is a portion of the second plate 17″ oblique to the first planar portion 72 located outwardly from each of the second plate inner peripheral edges 36″ and inwardly from each of the first planar portions 72.

As shown in FIG. 7, the first ramp portion 73 extends away from the third plate 18″. The first ramp portion 73 may be formed in the second plate 17″ during the stamping operation used to form the second plate 17″ or may be formed in a secondary operation after the stamping operation used to form the second plate 17″.

The second planar portion 74 is a portion of the second plate 17″ parallel to the first planar portion 72 located inwardly from each of the first ramp portions 73. As shown in FIG. 7, the second planar portion 74 is noncoplanar with the first planar portion 72. The second planar portion 74 may be formed in the second plate 17″ during the stamping operation used to form the second plate 17″ or may be formed in a secondary operation after the stamping operation used to form the second plate 17″.

The second ramp portion 75 is a portion of the second plate 17″ oblique to the second planar portion 74 located outwardly from each of the second plate inner peripheral edges 36″ and inwardly from the second planar portions 74. As shown in FIG. 7, the second ramp portion 75 extends towards the third plate 18″. The second ramp portion 75 may be formed in the second plate 17″ during the stamping operation used to form the second plate 17″ or may be formed in a secondary operation after the stamping operation used to form the second plate 17″.

FIG. 7 also illustrates a first plate whole bead 76 formed in the first plate 16″ similar to the second plate whole bead 70 including a first planar portion 77, a first ramp portion 78, a second planar portion 79, and a second ramp portion 80.

In accordance with the provisions of the patent statutes, the invention has been described in what is considered to represent its preferred embodiments. However, it should be noted that the invention can be practiced otherwise than as specifically illustrated and described without departing from its spirit or scope.

What is claimed is:

1. A multi-layer insert for a gasket, comprising:
a first plate having an inner peripheral edge defining an aperture therethrough and at least one first plate retention tab extending from an outer peripheral edge thereof; and
a second plate having an inner peripheral edge defining an aperture therethrough and an outer peripheral edge defining at least one second plate retention tab, the at least one second plate retention tab having a first position and a second position, the at least one second plate retention tab in the first position and the second position being substantially coplanar with the second plate, the outer peripheral edge of the second plate and the at least one second plate retention tab in the first position defining a first profile of the second plate, wherein the first plate and the second plate are fixed with respect to one another and a portion of the at least one second plate retention tab in the second position extends outwardly from the first profile of the second plate.

2. The multi-layer insert for a gasket according to claim 1, wherein the second plate includes at least one embossment forming a portion of each second plate retention tab.

3. The multi-layer insert for a gasket according to claim 1, wherein half beads are formed adjacent the inner peripheral edges of the first plate and the second plate, each of the half beads comprising a first planar section, a ramp, and a second planar section.

4. The multi-layer insert for a gasket according to claim 1, wherein whole beads are formed adjacent the inner peripheral edges of the first plate and the second plate, each of the whole beads comprising a first planar section, a first ramp section, a second planar section, and a second ramp section.

5. The multi-layer insert for a gasket according to claim 1, wherein an outer surface of the first plate and an outer surface of the second plate each have a coating applied thereto.

6. The multi-layer insert for a gasket according to claim 1, wherein the first plate and the second plate are formed from a stainless steel.

7. The multi-layer insert for a gasket according to claim 1, further comprising a third plate having an inner peripheral edge defining an aperture therethrough and an outer peripheral edge, the first plate and the second plate coupled to the third plate.

8. The multi-layer insert for a gasket according to claim 7, wherein the inner peripheral edges of the first plate, the second plate, and the third plate cooperate to form a portion of a fluid conduit.

9. The multi-layer insert for a gasket according to claim 7, wherein the outer peripheral edge of the third plate defines at least one third plate indent.

10. The multi-layer insert for a gasket according to claim 9, wherein the second plate includes at least one embossment formed adjacent each second plate retention tab and the at least one embossment extends into the third plate indent when the second plate retention tab is in the second position.

11. The multi-layer insert for a gasket according to claim 9, wherein the third plate includes at least two third plate indents, each of the third plate indents substantially aligned with at least two second plate retention tabs formed in the second plate.

12. The multi-layer insert for a gasket according to claim 11, wherein the first plate includes at least two plate retention tabs formed adjacent the third plate indents.

13. The multi-layer insert for a gasket according to claim 1, wherein the second plate includes at least one embossment formed adjacent each second plate retention tab.

14. The multi-layer insert for a gasket according to claim 13, wherein the second plate includes two embossments formed adjacent each second plate retention tab, one of the embossments forming a portion of each second plate retention tab.

15. A cylinder head gasket for an internal combustion engine having a multi-layer insert, the multi-layer insert comprising:
a first plate having an inner peripheral edge defining an aperture therethrough and at least two first plate retention tabs extending from an outer peripheral edge thereof;
a second plate having an inner peripheral edge defining an aperture therethrough, an outer peripheral edge defining at least two second plate retention tabs, and two embossments formed adjacent each of the second plate retention tabs, the at least two second plate retention tabs having a first position and a second position, the at least two second plate retention tabs in the first position and the second position substantially coplanar with the second plate, the outer peripheral edge of the second plate and the at least two second plate retention tabs in the first position defining a first profile of the second plate; and
a third plate having an inner peripheral edge defining an aperture therethrough and an outer peripheral edge defining at least two third plate indents, wherein the first plate and the second plate are coupled to the third plate and a portion of the at least two second plate retention tabs in the second position extend outwardly from the first profile of the second plate, and at least a portion of the second plate extends into each of the third plate indents when the second plate retention tab is in the second position.

16. The cylinder head gasket for an internal combustion engine according to claim 15, wherein at least one of the embossments formed in the second plate forms a portion of each second plate retention tab.

17. The cylinder head gasket for an internal combustion engine according to claim 15, wherein the at least two first plate retention tabs are formed adjacent the third plate indents.

18. The cylinder head gasket for an internal combustion engine according to claim 15, wherein the inner peripheral edges of the first plate, the second plate, and the third plate cooperate to form a portion of a fluid conduit.

19. The cylinder head gasket for an internal combustion engine according to claim 15, wherein half beads are formed adjacent the inner peripheral edges of the first plate and the second plate, each of the half beads comprising a first planar section, a ramp, and a second planar section.

20. A method for securing a multi-layer insert to a cylinder head gasket, the method comprising the steps of:
providing a first plate having at least two first plate retention tabs extending from an outer peripheral edge thereof;
providing a second plate having an outer peripheral edge defining at least two second plate retention tabs, at least one embossment formed adjacent each of the second plate retention tabs, the at least two second plate retention tabs being substantially coplanar with the second plate and the outer peripheral edge of the second plate and the at least one second plate retention tab defining a first profile of the second plate;
providing a third plate having an outer peripheral edge defining at least two third plate indents;
coupling the first plate and the second plate to the third plate to form the multi-layer insert having an insert profile, each of the third plate indents substantially aligned with at least two second plate retention tabs formed in the second plate;
providing the cylinder head gasket having a gasket edge at least partially corresponding to the insert profile;
abuttingly disposing the multi-layer insert against the gasket edge, the at least two first plate retention tabs disposed against a first face of the cylinder head gasket and extending past the gasket edge; and
deforming a portion of the second plate including at least one of the embossments formed in the second plate, wherein the portion of the second plate deformed is received by the third plate indents, such deformation causing at least a portion of each of the second plate retention tabs to extend outwardly from the first profile of the second plate, each of the second plate retention tabs disposed against a second face of the cylinder head gasket and extending past the gasket edge to couple the multi-plate insert to the cylinder head gasket.
